(19) United States
(12) Patent Application Publication
(10) Pub. No.: US 2014/0029076 A1
(43) Pub. Date: Jan. 30, 2014

(54) OPTICAL MODULE AND SCANNING TYPE IMAGE DISPLAY DEVICE

(71) Applicant: Hitachi Media Electronics Co., Ltd., Oshu-shi (JP)

(72) Inventors: Seiichi KATO, Tsuchiura (JP); Atsushi KAZAMA, Hitachinaka (JP); Masahiko KAMESAWA, Yokohama (JP); Teppei TANAKA, Yokohama (JP); Norio HOSAKA, Yokohama (JP)

(21) Appl. No.: 13/927,472

(22) Filed: Jun. 26, 2013

(30) Foreign Application Priority Data
Jul. 27, 2012 (JP) 2012-166478

(51) Int. Cl. G02B 26/10

(52) U.S. Cl. CPC G02B 26/10
USPC 359/204.1

(57) ABSTRACT

An optical module including a case to hold the optical module, and two sloped surfaces symmetrically formed to enclose a first surface including the optical axis of the optical component in an optical component holder retaining a portion of the optical component, a sloped surface is formed in the case at one position each so as to be formed opposite to the sloped surfaces at two positions of the optical component or optical component holder, and the one sloped surface of the optical component or optical component holder and the one sloped surface of the case at opposite side are symmetrical to the second surface parallel to the first surface and including the side intersecting the surface extending from the sloped surface of the case and the sloped surface of optical component or optical component holder, and the section between these sloped surfaces contains adhesive.

### BACKGROUND

The present invention relates to an optical module and scanning type image display device, and relates for example to an optical module to align and emit light beams from a plurality of lasers along one optical axis, and a scanning type image display device to display the light beam from the optical module as an image.

In recent years there has been intensive development of compact projectors that can easily be carried around by hand and show displays on a large screen. Compact projectors capable of connecting to note PC and devices such as video cameras having internal projectors capable of projecting recorded images are already commercially available, and cellular phones and smartphones will also likely contain such devices in the future.

Projector methods first included types using a lamp or LED in the light source and projecting an image on a liquid crystal panel or digital micro-mirror device (DMD). However, advances are also being made in developing laser projectors (scanning type image display devices) that utilize a laser as a light source to scan by way of a movable mirror with one light beam and display an image. Utilizing a laser as the light source eliminates the need for focusing alignment, allows easily increasing the brightness, and is ideal for applications in the field since images can be displayed on any convenient wall when outside the company or home.

Other potential uses include taking advantage of the high brightness image to project a display onto the front glass in automobiles and in heads-up displays for navigation tasks.

Japanese Unexamined Patent Application Publication (Translation of PCT Application) No. 2009-533715 for example discloses a structure for a scanning type image display device capable of displaying a color image, and including a beam coupler to merge and couple a three-color laser beam into a merged beam along one axis by utilizing a red, blue, and green three-color laser beam, and a beam scanner to scan along the polarized direction of the merged beam. The Japanese Unexamined Patent Application Publication (Translation of PCT Application) No. 2009-533715 discloses a beam coupler structure that arranges three light sources in parallel, the beams are emitted in the same direction, and each beam reflects from a corresponding beam coupler mirror and is coupled into a merged beam.

There was no laser in the related art for directly emitting green light so the invention of Japanese Unexamined Patent Application Publication (Translation of PCT Application) No. 2009-533715 converts the wavelength of the infrared light by SHG (second harmonic generation) to obtain green light. However in recent years, lasers that directly emit green light have become procurable.

### SUMMARY

In scanning type image display devices such as described above, precisely matching the three-color light beams along the optical axis and maintaining the optical axis against external disturbances such as from fluctuations in environmental temperature and occurring during operation is essential. Displacement of the optical axis causes displacement in the relative position at each color spot on the display area such as a screen, causing the problem of blurring of the image.

The module must therefore be adjusted and assembled so that the three color optical axis match each other. Adhesive is mainly used to hold the optical components in place after adjustment but displacement and rotation of the optical component position occurs after adjustment as the adhesive hardens. The adhesive may also thermally deform as the environmental temperature varies or a rise in temperature during usage of a scanning type image display device, or in other words rotation or positional displacement of the optical component may occur due to expansion or contraction of the adhesive. The issue was therefore how to solve the problem of optical axis displacement and rotation of the optical components.

There are structures where adhesive is mainly utilized as the method for attaching optical components. Japanese Unexamined Patent Application Publication No. 2002-196211 for example discloses a structure where a sloped surface is formed on the end of the lens and a sloped surface is formed on the part member, and contains adhesive between the sloped surfaces. Japanese Unexamined Patent Application Publication No. 2006-179074 discloses a structure where a sloped surface is formed on the part member and a curved surface is formed on the lens which is one of the optical components, and contains adhesive between the sloped surface and curved surface.

However, the related art gives no consideration to the following problems that occur in the optical module when the adhesive hardens, or when the adhesive expands or contracts due to the environmental temperature or a rise in temperature during usage of a scanning type image display device.

Shrink-hardening of the adhesive, or expansion or contraction of the adhesive applies force to the optical component, that displaces or rotates the optical component, and causes displacing the optical axis for each laser beam color, or namely causes the problem of displacement of the relative spot position on the display region such as the screen.

The descriptions in Japanese Unexamined Patent Application Publication No. 2002-196211 and Japanese Unexamined Patent Application Publication No. 2006-179074 disclose the adhesive positions but gave no description or suggestion regarding the problem of deviation of the optical axis relative to displacement of the optical component to which force was applied from shrink-hardening of the adhesive, expansion of the adhesive resulting from a rise in temperature during usage of a scanning type image display device, or expansion or contraction of the adhesive due to the environmental temperature during usage of a scanning type image display device.

An objective of the present invention is therefore to provide a compact optical module and scanning type image display device including an attachment structure for the optical components and capable of minimizing the relative position displacement of the spot on a display region such as a screen.

In order to address the aforementioned problems, the invention may for example include the following aspects.

This specification includes a plurality of methods for resolving the aforementioned problems. In an example of one such method, an optical module containing a laser for emitting a light beam from the laser, includes a case to hold the applicable optical module, a first sloped surface and a second sloped surface are symmetrically formed relative to a first surface including optical axis 11a in an optical component holder for retaining an optical component or a portion of the optical component; and a first sloped surface and second sloped surface of the case are symmetrically formed on the case relative to a first surface so as to form a pair with the first sloped surface and second sloped surface of the optical component holder.

A case sloped surface and a sloped surface for an optical component or optical component holder are each formed symmetrically relative to the two second surfaces that are parallel to and symmetrical to the first surface.

A case sloped surface and sloped surface for each optical component or optical component holder are featured in being formed so that the angles intersecting the second surface are equivalent, and contain adhesive between the sloped surfaces.

Moreover, for example an optical module with a case to hold an optical module, a first sloped surface and a second slope surface are formed relative to the first surface including an optical axis 11a in an optical component holder for retaining an optical component or a portion of an optical component; and a first sloped surface and a second sloped surface of the case are formed symmetrically on the case relative to the first surface so as to form a pair with the first sloped surface and the second sloped surface of the optical component holder.

A case sloped surface and a sloped surface for an optical component or an optical component holder are each formed symmetrically relative to the two second surfaces that are parallel and symmetrical to the first surface.

A sloped surface of a case and a sloped surface for an optical component or an optical component holder are each formed so that the angles intersecting the second surface are equivalent, and including a planar section parallel to the second surface extending consecutively from the sloped surface on the case and an optical component holder retaining an optical component or a portion of an optical component along the direction of the second surface from the narrow section of the sloped surfaces, and containing adhesive between the sloping surfaces.

Also for example an optical module with a case to hold an optical module a first curved surface and a second curved surface are symmetrically formed relative to a first surface including an optical axis 11a in an optical component holder for retaining an optical component or a portion of an optical component, and the first curved surface and second curved surface of the case are symmetrically formed in the case relative to the first surface so as to form a pair with the first curved surface and second curved surface of the optical component holder.

A curved surface of a case and a curved surface of an optical component or optical component holder are each formed symmetrically relative to two second surfaces that are parallel to and symmetrical to a first surface.

A unique feature is that curved surface of a case and curved surface of an optical component holder or optical component are each formed at equivalent angles to the second surface, and that contains adhesive between the curved surfaces.

Also for example an optical module with a case for mounting an optical module, a first curved surface and a second curved surface are symmetrically formed relative to a first surface including an optical axis 11a in an optical component holder for retaining an optical component or a portion of an optical component, and the first curved surface and second curved surface of the case are symmetrically formed in the case relative to the first surface so as to be a pair with the first curved surface and second curved surface of the optical component holder.

A curved surface of a case and a curved surface for an optical component or optical component holder are each formed symmetrically relative to two second surfaces that are parallel to and symmetrical to a first surface.

A curved surface of a case and a curved surface for an optical component or an optical component holder are each formed so that the angles intersecting the second surface are equivalent, and including a planar section parallel to the second surface extending consecutively from the curved surface on the case and an optical component holder retaining an optical component or a portion of an optical component along the direction of the second surface from the narrow section of the curved surfaces, and containing adhesive between the curved surfaces.

An optical module containing plural lasers and emitting a light beam from the plural lasers and comprising: a case to contain the applicable optical module, an optical component holder to hold the optical component or a portion of the optical component (hereafter called optical component holder and so on); two symmetrical approximately V-shaped groove spaces enclosing at least the optical component holder and so on, between the case and the optical component holder and so on; an open space at the bottom of the approximately V-shaped groove spaces; and adhesive in the V-shaped groove spaces to fasten the optical component holder and so on to the case.

A further unique feature is that optical component holder and soon is clamped by contact with the V-shaped groove formed in the case.

The invention also includes a scanning type image display device that regulates the light emitted from the laser and displays an image.

The present invention is capable of providing an optical module and scanning type image display device capable of minimizing the relative position displacement of the spot on a display region such as a screen.

The present invention is capable of providing a scanning type image display device including an optical module having an attachment structure for an optical component holder retaining an optical component or an optical component capable of minimizing the relative position displacement of a laser spot from plural lasers, on a display region such as a screen for example in heads-up display mounted in automobiles, etc.

Moreover, by forming a symmetrical sloped surface an attachment member such as adhesive can enlarge the freed surface area relative to the adhesive so that the force applied due to the deforming of the adhesive itself during expansion or shrinking can be absorbed by deforming of that freed surface, the concentrated strain on the adhesive surface can be alleviated, and peeling of the adhesive can be prevented.

The issues, structure, and effects other than described above will become readily apparent from the following description of the embodiments.

### BRIEF DESCRIPTION OF THE DRAWINGS

FIG. 1 is an overall structural view of the scanning type image display device of the embodiment of the present invention;

FIG. 2 is a perspective view showing the laser light source module of the embodiment of the present invention;

FIG. 3 is a perspective view showing an embodiment of the attachment structure for optical component utilized in the present invention;

FIG. 4 is a cross sectional view for describing the effect of the embodiment of the attachment structure for the optical component utilized in the present invention;

FIG. 5 is a cross sectional view for describing the problem with the attachment structure for the optical component utilized in the comparative example;

FIG. 6 is a cross sectional view for describing the second embodiment of the attachment structure for the optical component utilized in the present invention; and

FIG. 7 is a cross sectional view showing the third embodiment of the attachment structure for the optical component utilized in the present invention.

### DETAILED DESCRIPTION

The embodiments of the present invention are described next while referring to the accompanying drawings. Structural elements where the same reference numerals are attached have the same functions so if a description has already been given then that description is omitted. Moreover, an orthogonal coordinate axis containing an X axis, a Y axis and a Z axis is described on the required drawing in order to clarify the description of each part position.

### First Embodiment

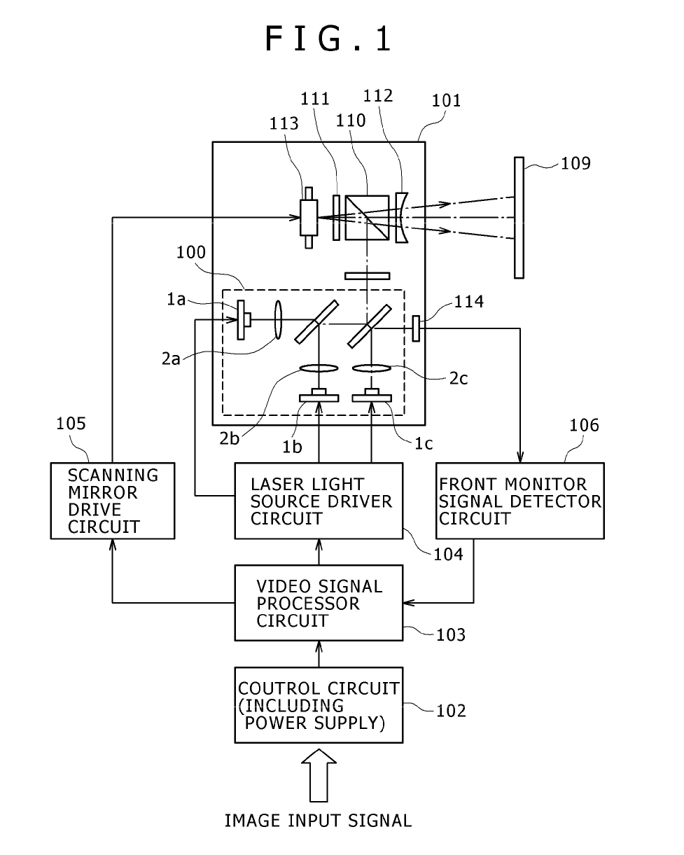

FIG. 1 is an overall structural view of the scanning type image display device of the embodiment of the present invention.

In FIG. 1, an optical module 101 includes a laser light source module 100 containing a first laser 1a, a second laser 1b, and a third laser is corresponding to the respective three colors green (G), blue (B), and red (R) and serving as the laser light source; and a beam coupler to merge and couple the beam light emitted from each laser light source and that passed through the so-called collimator lens of a first lens 2a, a second lens 2b, and a third lens 2c; a projector section to project the coupled beam light onto a screen 109, and a scanning unit to two-dimensionally scan the projected beam light on the screen 109. The projector section includes a polarized beam splitter (PBS) 110, a ¼ wavelength plate 111, a screen size enlarger element 112, etc. The scanning section includes a scanning mirror 113, etc.

The image input signal for display is input to the video signal processor circuit 103 by way of the control circuit 102 that includes a power supply, etc. Along with performing all types of video processing on the image signal, the video signal processor circuit 103 separates the three color signals R,G,B and sends the separated color signals to the laser light source drive circuit 104. In the laser light source drive circuit 104, a drive current for light emission is supplied to the corresponding laser within the laser light source module 100, according to the luminance value of each R,G,B signal. The laser consequently emits a light beam at an intensity corresponding to the luminance value of the R, G, and B signals and that matches the display timing.

The video signal processor circuit 103 extracts a synchronizing signal from the image signal and sends the synchronizing signal to a scanning mirror drive circuit 105. This scanning mirror drive circuit 105 supplies a drive signal to repeatedly rotate the mirror surface two-dimensionally to the scanning mirror 113 within the optical module 101 at a timing matching the horizontal and vertical synchronizing signals. The scanning mirror 113 receives this drive signal and periodically and repeatedly rotates the mirror surface to just a specified angle, reflecting the light beam, and scanning the light beam vertically and horizontally on the screen 109 to display the image.

The signal from the front monitor 114 is input to the front monitor signal detector circuit 106 that detects the respective R, G, and B output levels emitted from the laser. The front monitor signal detector circuit 106 inputs the detected output levels to the video signal processor circuit 103 and regulates the output from the lasers so as to attain a specified output.

A dual-axis drive mirror manufactured using MEMS (Micro Electro Mechanical Systems) technology can for example be utilized in the scanning mirror 113. The drive system may utilize piezoelectric, static electricity, or electromagnetic drive, etc. Two single-axis drive scanning mirrors may be utilized and positioned so as to scan the light beams in mutually perpendicular directions.

The laser light source module 100 of the present invention is described next.

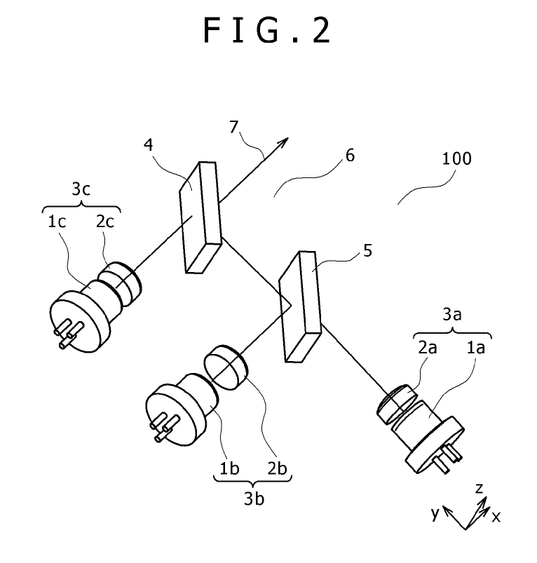

FIG. 2 is a perspective view showing the laser light source module.

The laser light source module 100 in FIG. 2, contains a first laser light source 3a comprised of a first laser 1a and a first lens 2a, a second laser light source 3b comprised of a second laser 1b and a second lens 2b; and a third laser light source 3c comprised of a third laser 1c and a third lens 2c; and a beam coupler 6 comprised of a first mirror 4 and a second mirror 5.

The first laser 1a, second laser 1b, third laser 1c respectively emit green-colored, blue-colored, and red-colored (G, B, R) laser light. The first lens 2a, second lens 2b, and third lens 2c are so-called collimator lenses, that set the laser light emitted from the respective laser light sources as an approximately parallel light beam. The light beam from each light source is arrayed along the merged light beam optical axis 7 by the beam coupler 6 and emitted outside the laser light source module 100.

The red light beam from the third laser 3c transmits through the first mirror 4. The blue light beam from the second laser light source 3b reflects from the first mirror 4 after reflecting from the second mirror 5. The green light beam from the first laser light source 3a transmits through the second mirror 5, reflects from the first mirror 4, and is arrayed along the respective merged light beam optical axis 7. In order to form the above described light path, the first mirror 4 is a dichroic mirror designed to allow a red wavelength light beam to transmit through, and to reflect blue and green wavelength beams; and the second mirror 5 is a dichroic mirror designed to reflect the blue wavelength light beam, and allow the green wavelength light beam to transmit through it.

The placement of the laser light source described here is one example, and the placement of the first, the second, and the third laser light sources is not dealt with here.

However, adhesive is generally utilized as the method for attaching the optical components. Shrink-hardening of the adhesive, expansion of the adhesive resulting from a rise in temperature during usage of the scanning type image display device, or expansion or contraction of the adhesive due to the environmental temperature during usage of the scanning type image display device applies force to the optical component, that displaces or rotates the optical component, displacing the optical axis for laser beam of each color, or namely causes the problem of displacement of the relative spot position on the display region such as the screen.

Deviation or displacement of the optical axis of the light beam causes displacement in the corresponding position at each spot on the display area such as a screen. When the spot position displacement of all three lasers is different, the spot positions will not match and the image is blurred.

Whereupon the present embodiment of the invention, discloses an attachment structure for an optical component that prevents displacement of the optical axis from occurring such as rotation or displacement of the optical components due to a force applied by shrink-hardening, expansion, contraction in the attachment member such as adhesive, etc.

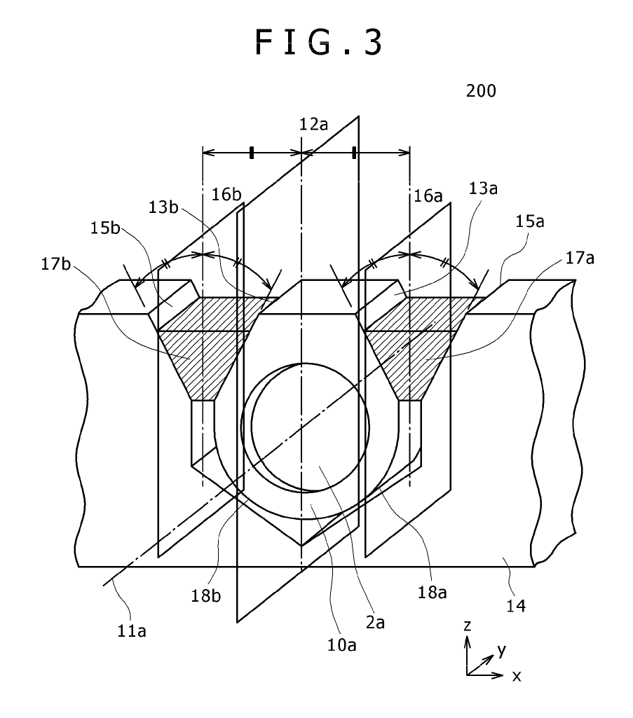

An attachment structure 200 for optical component in the embodiment of the present invention is described next. FIG. 3 is a perspective view showing the first embodiment of the attachment structure for optical components in the optical module utilized in the present invention.

In an attachment structure 200 for optical components in FIG. 3, a first lens 2a is retained in an optical component holder 10a for retaining the first lens 2a. In the optical component holder 10a, a sloped surface 13a and a sloped surface 13b are formed symmetrically relative to a first surface 12a (yz planar surface) including an optical axis 11a of the first lens 2a. The first surface 12a is preferably a planar surface perpendicular to the case 14 bottom surface, however can be changed to retain the optical components against external disturbances such as during operation or temperature fluctuations due to changes in the environmental temperature, and changed within a range needed to render the effect of alleviating displacement of the three color beam relative spot position.

On the case 14 of the optical module 101 for attaching the optical component holder 10a, the sloped surface 15a and sloped surface 15b of case 14 are formed so as to form a pair with the sloped surface 13a and sloped surface 13b of the optical component holder 10a. The sloped surface 15a and sloped surface 15b have a symmetrical relation with the first surface 12a. Moreover, Second surfaces 16a and 16b are in parallel to and symmetrical to the first surface, and the sloped surface 13a and sloped surface 15a are formed symmetrical to the second surface 16a, and a sloped surface 13b and sloped surface 15b are formed symmetrical to the second surface 16b. The sloped surface 13a and sloped surface 15a are formed so that the angles intersecting the second symmetrical surface 16a are equivalent. The sloped surface 13b and sloped surface 15b are formed in the same way so that the angles intersecting the second symmetrical surface 16b are equivalent.

The direction with a wide opening for the sloped surface 13a and sloped surface 15a is formed as an opening away from the optical axis 11a of the lens 2a, and an attachment member such as the adhesive 17a is in the space between the sloped surface 13a and sloped surface 15a.

In the same way, the direction with the wide opening for the sloped surface 13b and sloped surface 15b is formed as an opening away from the optical axis 11a of the lens 2a, and an attachment member such as the adhesive 17b is in the space between the sloped surface 13b and sloped surface 15b.

The second lens 2b and the third lens 2c also have the same optical component attachment structure as the first lens 2a.

Adjustment on the optical axis 11a is necessary in the case of a collimator lens such as the first lens 2a, so to simplify the adjustment along the optical axis (y direction in FIG. 3), the sloped surfaces 18a, 18b may be formed in a V shape in the case 14, and the optical component holder 10a may be adjusted while in contact with the same sloped surfaces 18a, 18b. In that case, the sloped surfaces 18a, 18b forming the V shape in the case 14 have a symmetrical relation with the first surface 12a, and the surface where the optical component holder 10a contacts the same sloped surfaces 18a, 18b is preferably a cylindrical surface parallel to the optical axis 11a.

Though not shown in the drawing, the second lens 2b and the third lens 2c may also employ the same structure as the first lens 2a where a V shape is formed in the case 14, and the optical component holder 10b corresponding to the second lens 2b, and the optical component holder 10c corresponding to the third lens 2c make contact with the V-shaped sloped surface so as to be a structure adjustable along the optical axis.

In the above description, the lens 2a was retained in the optical component holder 10a however a lens may be formed by a mold for the sloped surface 13a and sloped surface 13b of optical component holder 10a in the lens 2a itself.

The lens 2a was utilized as the optical component in the above description but an optical component other than a lens, such as a diffraction grating may also be employed.

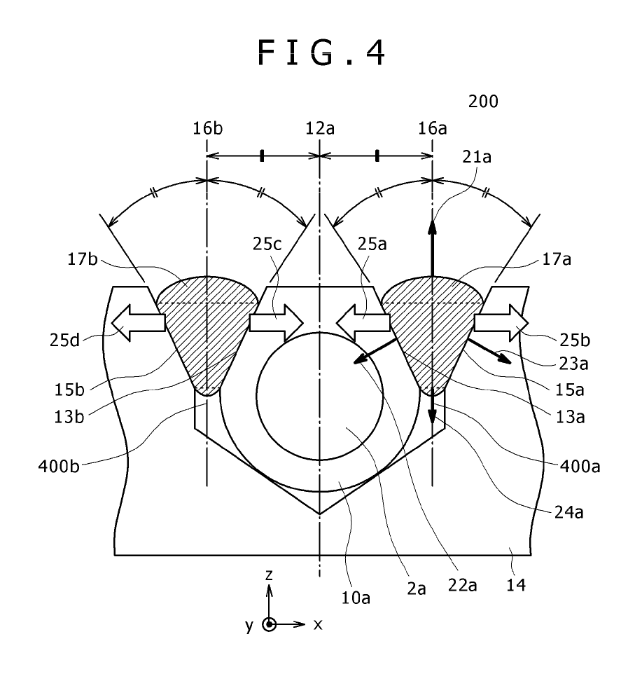

FIG. 4 is a cross sectional view for describing the effect of the embodiment of the present invention.

FIG. 4 shows a cross sectional view of the attachment structure 200 for the optical component in FIG. 3. If there is an adhesive 17a contained between the sloped surface 13a of the optical component holder 10a and the sloped surface 15a of the case 14, the adhesive expands (shape deforms) due to a rise in temperature, a force 21a acts on the upper edge (+z direction) in the figure, a force 22a perpendicular to the sloped surface 13a acts in the sloped surface 13a of the optical component holder 10a, a force 23a perpendicular to the sloped surface 15a acts in the sloped surface 15a of the case 14, and a force 24a acts in the direction of the narrow section 400a (−z direction) of the lower edge of the adhesive 17a in the figure. As a result of the combined forces 21a, 22a, 23a, and 24a from the effect of symmetrical positions of the sloped surface 13a and the sloped surface 15a relative to the second surface 16a, and due to the release of the force from the open surface at the upper edge, a force 25a acts in the left direction (−x direction) in the figure in the optical component holder 10a, and a force 25b acts in the rightward direction (+x direction) in the figure in the case 14 so that no upward/downward force (z direction) in the figure occurs.

In the same way, for the adhesive 17b on the another pair of sloped surfaces 13b, 15b, releasing the force from the open surface at the upper edge in the figure and the effect of the symmetrical surface 13b and symmetrical surface 15b of the second surface 16b, causes a force 25c to act in the rightward direction (+x direction) in the figure in the optical component holder 10a, and a force 25d to act in the leftward direction (−x direction) in the figure in the case 14 so that no upward/downward force (z direction) in the figure occurs. The forces 25a, 25b and forces 25c, 25d, balance the force in the left/right direction (x direction) in the figure symmetrically relative to the first surface 12a, rendering a structure that suppresses displacement and rotation of the lens 2a due to expansion of the adhesive.

The above description showed effects rendered on expansion (swelling) of the adhesive 17a, 17b when there is arise in temperature, however the above structure also suppresses displacement and rotation of the lens 2a due to contraction of the adhesive 17a, 17b when there is a drop in temperature or in other words fluctuations in the environmental temperature, during shrink-hardening when the adhesive is hardening, or during expansion of the adhesive due to a rise in temperature during usage of the scanning type image display device.

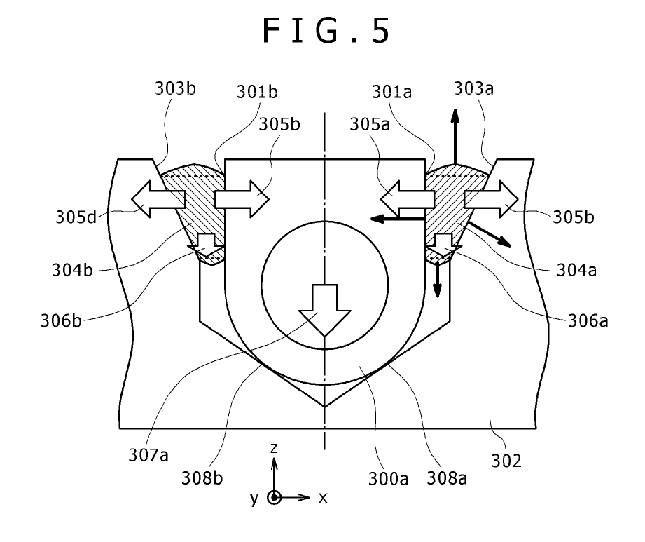

FIG. 5 shows the attachment structure for the optical component holder 300a utilized as the comparative example. The sloped surfaces of the optical component holder 300a extend upward and downward (z direction) in the figure however for the purposes of clarifying the description the surfaces are called surface 301a, 301b.

Unlike the drawings as shown in FIG. 3 and FIG. 4, in the optical component holder 300a of the comparative example in FIG. 5, the surface 301a, 301b of optical component holder 300a and the sloped surfaces 303a, 303b of case 302 are not formed symmetrical to the second surface 16a and the second surface 16b. When expansion (swelling) of the adhesive 304a occurs between the surface 301a and sloped surface 303a, and expansion of the adhesive 304b occurs between the surface 301b and sloped surface 303b, the release of the combined force from those expansion is therefore insufficient due to the open surface at the upper edge in the figure, so that a force 305a and a force 305b acting in the left/right directions (x direction) in the figure, and a force 306a acting in the downward direction (z direction) in the figure are generated. A combined force from the adhesive 304b causes a force 305c and force 305d acting in the left/right directions (x direction) in the figure, and a force 306b acting in the downward direction (z direction) in the figure in the same way. The combined force from the forces 306a, 306b on the adhesives 304a, 304b therefore causes a force 307a acting in the downward (−z direction) in the figure on the optical component holder 300a. In FIG. 5, no displacement occurs along the upward/downward direction (z direction) because of optical component holder contact with the V shaped sloped surfaces 308a, 308b in case 302. However, the optical component holder 300a is displaced in the upward (+z direction) in the figure on account of a force acting in the reverse direction of the above force 307a when the adhesive 304a, 304b contracts due to drop temperature caused by the environmental temperature, or shrink-hardening of the adhesive 304a, 304b. This displacement causes displacement of the optical axis so that displacement of the relative spot position for each color on the display region such as the screen occurs, leading to the problem of the image blurring. Displacement due to shrink-hardening of the adhesive 304a, 304b in particular occurs immediately after adjustment and so is directly related to the problem of deterioration in product quality.

A compact optical module 101 and scanning type image display device can be provided that resolves the above problems by preventing displacement and rotation of the lens 2a by forming the slope shown in FIG. 3 in the case 14 and the optical component holder 10a to minimize displacement of the relative spot position on a display region such as the screen.

### Second Embodiment

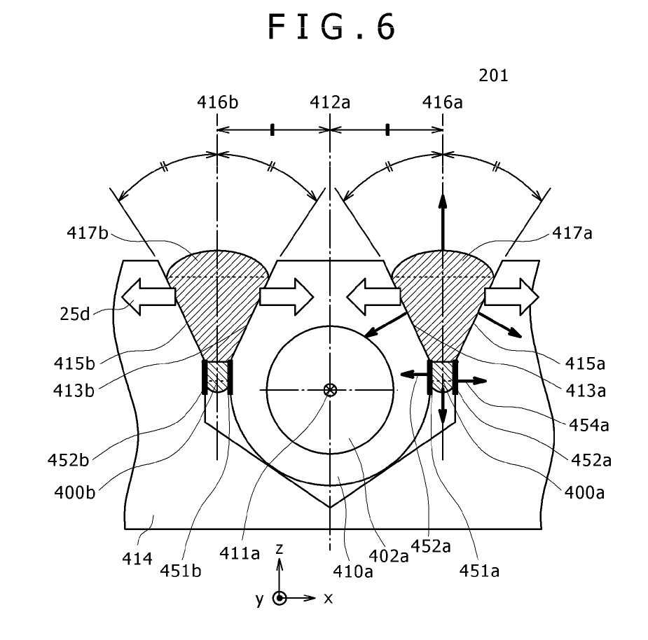

FIG. 6 is a cross sectional view showing the second embodiment of the attachment structure for the optical component of the optical module utilized in the present invention.

The attachment structure 200 for the optical component shown in FIG. 3 and FIG. 4 prevents rotation and displacement in the optical component. When there is adhesive between the sloped surface 13a of the optical component holder 10a and the sloped surface 15a of the case 14, the adhesive sometimes droops from the narrow section 400a of the two sloped surfaces 13a and sloped surface 15a. However, the drooped adhesive that forms an attachment structure 201 for the optical component as shown in FIG. 6 can prevent displacement or rotation of the lens 2a.

The attachment structure 201 for the optical component retains the first lens 402a in the optical component holder 410a.

A sloped surface 413a and sloped surface 413b are formed symmetrical to a first surface 412a (yz planar surface) including an optical axis 411a of the first lens 402a, on the optical component holder 410a. A sloped surface 415a and a sloped surface 415b of the case 414 are rendered so as to form a pair with the sloped surface 413a and sloped surface 413b of the optical component holder 410a, on the case 414 for the optical module 101 on which the optical component holder 410a is mounted. The sloped surface 415a and a sloped surface 415b are mutually symmetrical to the first surface 412a. On the second surfaces 416a and 416b that are parallel to and symmetrical to the first surface 412a: a sloped surface 413a and a sloped surface 415a are formed symmetrically relative to the second surface 416a, and a sloped surface 413b and sloped surface 415b are formed symmetrically relative to the second surface 416b. The sloped surface 413a and a sloped surface 415a are formed at equivalent angles intersecting the second symmetrical surface 416a. The sloped surface 413b and sloped surface 415b are in the same way formed at equivalent angles intersecting the second symmetrical surface 416b.

The optical component holder 410a includes a surface 451a parallel to the second symmetrical surface 416a and connecting to the sloped surface 413a. The case 414 in the same way includes a surface 452a parallel to the second symmetrical surface 416a and connecting to the sloped surface 415a. The parallel surface 451a of the optical component holder 410a and the parallel surface 452a of the case 414 are symmetrical with the second symmetrical surface 416a.

The direction with a wide opening for the sloped surface 413a and sloped surface 415a is formed as an opening away from the optical axis 411a of the lens 402a, and there is an attachment member such as the adhesive 417a is in the space between the sloped surface 413a and sloped surface 415a.

The attachment member such as adhesive drooping on the narrow section 400a between the sloped surfaces, generates the forces 453a, 454a in a direction perpendicular to the parallel surface 451a of the optical component holder 410a and the parallel surface 452a of case 414, and the force is equal in the left/right directions (x direction) in the figure. Other than the above, the adhesive exerts no force other than in the figure in the left/right directions (x direction) as shown in FIG. 4 so that no force occurs in the upward/downward directions (Z direction) in the figure.

The optical component holder 410a in the same way includes a surface 451b parallel to the second surface 416b and connecting to the sloped surface 413b; and the case 414 in the same way includes a surface 452b parallel to the second surface 416b and connecting to the sloped surface 415b. The parallel surface 451b of the optical component holder 410a and the parallel surface 452b of the case 414 are symmetrical to the second surface 416b.

The direction with a wide opening for the sloped surface 413b and sloped surface 415b is formed as an opening away from the optical axis 411a of the lens 402a, and there is an attachment member such as the adhesive 417b is in the space between the sloped surface 413b and sloped surface 415b.

The attachment member such as adhesive drooping on the narrow section 400b between the sloped surfaces, generates the forces 453b, 454b in a direction perpendicular to the parallel surface 451b of the optical component holder 410a and the parallel surface 452b of case 414, and the force is equal in the left/right directions (x direction) in the figure so that no force is exerted in the upward/downward directions (Z direction) in the figure.

A compact optical module 101 and scanning type image display device can be provided that is capable of minimizing displacement of the relative spot position on a display region such as the screen by way of the above described effect that prevents displacement and rotation of the first lens 2a caused by expansion and contraction of the adhesive due to a rise or drop in temperature during usage of the scanning type image display device or during shrink-hardening when the adhesive is hardening or from fluctuations in the environmental temperature.

Though not shown in the drawing, the second lens 402b and the third lens 402c may also employ the same optical component attachment structure as the first lens 402a.

### Third Embodiment

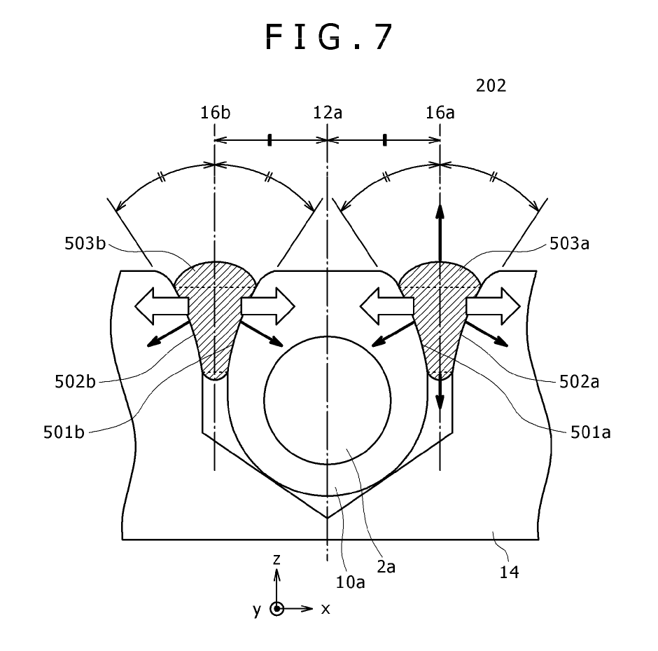

FIG. 7 is a cross sectional view showing the third embodiment of the attachment structure for the optical component of the optical module utilized in the present invention.

The point where the present embodiment differs from the first embodiment and the second embodiment is that the sloped surface 13a and sloped surface 13b of the optical component holder 10a are changed to the curved surface 501a and curved surface 501b; and that the sloped surface 15a and sloped surface 15b of case 14 are changed to the curved surface 502a and curved surface 502b. The curved surface 501a, curved surface 501b, curved surface 502a, and curved surface 502b have the same curvature, and the center axis of the curved surface are parallel to the optical axis 11a of the lens 2a. The second symmetrical surface 16a is parallel to the first surface 12a and extends along the center of the gap between the curved surface 501a and curved surface 502a, and the curved surface 501a of the optical component holder 10a and the curved surface 502a of the case 14 are symmetrical to the second symmetrical surface 16a.

The second symmetrical surface 16b is parallel to the first surface 12a and extends along the center of the gap between the curved surface 501b and curved surface 502b, and the curved surface 501b and curved surface 502b are symmetrical to the second symmetrical surface 16b.

There is an attachment member such as adhesive 503a between the curved surface 501a of the optical component holder 10a and the curved surface 502a of the case 14; and an attachment member such as the adhesive 503b between the curved surface 501b of the optical component holder 501b and the curved surface 502b of the case 14.

A compact optical module 101 and scanning type image display device can be provided that obtain the same effects as shown for the sloped surfaces since the curved surface 501a and curved surface 502a, and the curved surface 501b and curved surface 502b are symmetrical with each other; and moreover is capable of minimizing displacement of the relative spot position on a display region such as the screen by preventing displacement and rotation of the first lens 2a caused by expansion and contraction of the adhesive due to a rise in temperature during usage of the scanning type image display device or during shrink-hardening when the adhesive is hardening or from fluctuations in the environmental temperature.

In the above description, the lens 2a was retained in the optical component holder 10a however the lens 2a may itself be utilized in a mold shape containing the curved surface 501a and the curved surface 501b for the optical component holder 10a.

The lens 2a was utilized as the optical component in the above description but an optical component other than a lens, such as a diffraction grating may also be employed.

The surface area of the open surface per each unit of adhesive 17a can moreover be enlarged by way of an attachment member such as the adhesive 17a, the force occurring due to deformation on the open surface due to deformation in the adhesive 17a itself during expansion or contraction of the adhesive 17a can be absorbed, the concentrated strain on the adhesive surface can be alleviated, and peeling of the adhesive can be prevented. The embodiment also renders the effect of increasing the reliability of the adhesive in cases involving a wide environmental temperature range such as for heads-up displays mounted in automobiles, etc.

The compact optical module and scanning type image display device containing that optical module of the above described present invention for arraying the light beams from a three color (red, green, and blue) lasers on one combined beam along the optical axis, is capable of reducing the displacement of the relative positions of the three color beam spots (3 points or spots made by the light beam from the three-color laser light source on the projection surface such as a screen).

The first surface 12a, the second surface 16a, the second surface 16b, the first surface 412a (yz plane surface), the second surface 416a and the second surface 416b are hypothetical planes for clarifying the positional relationships within the structure.

In the present embodiment, the first surface is assumed as approximately perpendicular to the bottom of the case including the light axis of the optical component, however if capable of preventing or reducing the expansion of the adhesive within an allowable range due to temperature fluctuations caused by changes during operation or fluctuations in the environmental temperature, then the first surface need not always be approximately perpendicular to the bottom of the case.

In the above embodiments, the expressions: “parallel”, “symmetrical”, “equivalent angles”, and “V shape” and so on were utilized for expressing positional relationships, however each expression may also include the case of “approximately parallel”, “approximately symmetrical”, “approximately equivalent angles”, and “approximate V shape” and so on without departing from the scope of the present invention.

The first surface shown by the reference numeral 12a for example is assumed as approximately perpendicular to the bottom of the case including the light axis of the optical component, however if capable of preventing or reducing the expansion of the adhesive within an allowable range due to temperature fluctuations caused by changes during operation or fluctuations in the environmental temperature, then the first surface need not always be approximately perpendicular to the bottom of the case.

These specifications reveal problems for example an optical modules containing plural lasers and emitting laser light beam from the plural lasers in which the optical module that arrays the light beams from three color (red, green, and blue) lasers on one combined beam along the optical axis must maintain the optical component against external disturbances such as temperature changes due to fluctuations in the environmental temperature or during operation, and also must reduce the displacement of the relative positions of the three color beam spots. As a means to resolve the above mentioned problems, for example, an optical module is disclosed including a case to hold the optical module, sloping surfaces formed at two positions symmetrically enclosing a first surface including the optical axis of the optical component on an optical component or an optical component holder retaining the optical component; sloping surfaces formed at one position each on the case on a surface opposite the two sloped surface locations for the optical component or the optical component holder retaining the optical component; and one sloping surface position on the optical component or the optical component holder retaining the optical component and one sloping surface position on the case on the opposite surface, are symmetrical relative to a second symmetrical surface parallel to the first surface and including a side intersecting at the extension plane of the sloped surface of the case and the sloped surface of the optical component or the optical component holder retaining the optical component; and having adhesive between these sloped surfaces.

The present embodiment is not limited by the above described embodiments and may include all manner of adaptations and variations. The above embodiments were described in detail in order to make the present invention easy to understand, and the invention is not necessarily always restricted to containing all of the structure that was described. Moreover, a portion of the structure of a certain embodiment may be substituted into the structure of another embodiment, or the structure of another embodiment may be added to the structure of a certain embodiment. Moreover other structures can be added, deleted, or substituted to or from a portion of the structure of each embodiment.

Further, each of the above described structures, functions, processors and processing methods can for example be implemented in whole or in part by hardware such as an integrated circuit design. Each of above described function and the structure and so on can also be implemented by way of software by the processor that interprets and implements the programs for implementing each function. Information such as for each program, table, or file for implementing each function may be stored on a recording device such as a memory, hard disk, or SSD (Solid State Drive) and so on, or may be placed on a recording medium such as an IC card, SD card, or DVD, etc.

The control lines or information lines are shown as considered necessary for rendering a description however the description does not necessarily show all of the control lines or information lines from a product standpoint. All of the structures can in fact be considered as mutually connected.

What is claimed is:

1. An optical module containing a plurality of lasers and emitting a light beam from the lasers, comprising:
a case to hold the applicable optical module; and
an optical component holder to hold the optical component or a portion of the optical component (hereafter called optical component holder and so on),
wherein a first sloped surface and a second sloped surface are formed approximately symmetrical to the first surface including the optical axis in the optical component holder and so on, and a first sloped surface and a second sloped surface of the case are formed in the case approximately symmetrical to the first surface so as to form a pair with the first sloped surface and the second sloped surface of the optical component holder,
wherein the sloped surfaces of the case and sloped surfaces of the optical component holder and so on are each formed symmetrical to two second surfaces that are approximately parallel and approximately symmetrical to the first surface, and
wherein the sloped surface of the case and sloped surface of the optical component holder and so on are each formed to intersect the second surface at approximately equivalent angles, and the section between the sloped surfaces contains adhesive.

2. The optical module according to claim 1,
wherein the optical module includes a planar section approximately parallel to the second surface and extending consecutively from the sloped surfaces of the case and optical component holder, along the direction of the second surface from a narrow section of the sloped surface of the case and sloped surface of the optical component holder.

3. An optical module containing a plurality of lasers and emitting a light beam from the lasers, comprising:
a case to hold the applicable optical module; and
an optical component holder to hold the optical component or a portion of the optical component (hereafter called optical component holder and so on),
wherein a first curved surface and a second curved surface are formed approximately symmetrical to the first surface including the optical axis in the optical component holder and so on, and a first curved surface and a second curved surface of the case are formed in the case, approximately symmetrical to the first surface so as to form a pair with the first curved surface and the second curved surface of the optical component holder,
wherein the curved surfaces of the case and curved surfaces of the optical component holder and so on are each formed approximately symmetrical to two second surfaces that are approximately parallel and approximately symmetrical to the first surface, and
wherein the curved surface of the case and curved surface of the optical component holder and so on are each formed to intersect the second surface at approximately equivalent angles, and the section between the sloped surfaces contains adhesive.

4. The optical module according to claim 3,
wherein the optical module includes a planar section approximately parallel to the second surface and extending consecutively from the curved surfaces of the case and optical component holder, along the direction of the second surface from a narrow section of the curved surface of the case and curved surface of the optical component holder.

5. An optical module containing a plurality of lasers and emitting a light beam from the lasers, comprising:
a case to hold the applicable optical module;
an optical component holder to hold the optical component or a portion of the optical component (hereafter called optical component holder and so on);
two approximately symmetrical and approximately V-shaped groove spaces enclosing at least the optical component holder and so on, between the case and the optical component holder and so on;
an open space at the bottom section of the approximately V-shaped groove spaces; and
adhesive in the approximately V-shaped groove space to attach the optical component holder and so on to the case.

6. The optical module according to claim 5,
wherein the optical component holder and so on is clamped by contact with the groove formed in the case.

7. A scanning type image display device including the optical module according to claim 1,
wherein the optical module regulates light emitted from the laser to display an image.

8. A scanning type image display device including the optical module according to claim 2,
wherein the optical module regulates light emitted from the laser to display an image.

9. A scanning type image display device including the optical module according to claim 3,
wherein the optical module regulates light emitted from the laser to display an image.

10. A scanning type image display device including the optical module according to claim 4,
wherein the optical module regulates light emitted from the laser to display an image.

11. A scanning type image display device including the optical module according to claim 5,
wherein the optical module regulates light emitted from the laser to display an image.

12. A scanning type image display device including the optical module according to claim 6,
wherein the optical module regulates light emitted from the laser to display an image.
